(19) United States
(12) Patent Application Publication
(10) Pub. No.: US 2020/0314066 A1
(43) Pub. Date: Oct. 1, 2020

(54) VALIDATING FIREWALL RULES USING DATA AT REST

(71) Applicant: CLOUDFLARE, INC., San Francisco, CA (US)

(72) Inventors: Alex CRUZ FARMER, London (GB); Andrew GALLONI, Tonbridge (GB)

(21) Appl. No.: 16/370,754

(22) Filed: Mar. 29, 2019

(51) Int. Cl. H04L 29/06; H04L 12/26; H04L 9/32

(52) U.S. Cl. CPC H04L 63/0263; H04L 9/3271; H04L 43/50; H04L 63/0245

(57) ABSTRACT

A control server receives configuration data from a domain owner device associated with a domain owner of a resource, where the resource is hosted by an origin server. The control server uses the configuration data to generate a firewall rule to apply to requests directed to the resource and received by the edge server. The control server retrieves test traffic relevant to the firewall rule and applies the firewall rule to the test traffic. The control server determines an outcome from applying the firewall rule to the test traffic and, based on an input from the domain owner device, performs an action on the firewall rule.

### FIELD

Embodiments of the invention relate to the field of network communications; and more specifically, to validating firewall rules using data at rest.

### BACKGROUND

Internet hosts are concerned with maintaining high security, performance, and reliability of their hosted resources, such as websites. As the popularity of a resource increases, so does the amount of network traffic that is directed to the resource. Malicious or otherwise unwanted network traffic can affect the security, performance and reliability of a resource. Conventionally, a firewall uses rules to block or allow network traffic.

### BRIEF DESCRIPTION OF THE DRAWINGS

The invention may best be understood by referring to the following description and accompanying drawings that are used to illustrate embodiments of the invention. In the drawings:

FIG. 1 illustrates an exemplary system according to some embodiments described herein;

FIG. 2 is a flow diagram that illustrates exemplary operations for generating and testing firewall rules using test traffic, according to an embodiment;

FIG. 3 is a flow diagram that illustrates exemplary operations for applying firewall rules to a request packet according to an embodiment, according to an embodiment; and

FIG. 4 is a block diagram illustrating a data processing system that can be used in an embodiment.

### DESCRIPTION OF EMBODIMENTS

A server receives configuration data from a domain owner device. The domain owner device may be associated with a domain owner of a resource hosted by an origin server. In one embodiment, the server is a control server associated with one or more edge servers of a distributed edge computing network. The server uses the configuration data to generate a firewall rule to apply to requests directed to the resource and received by the edge server. Prior to applying the firewall rule to live traffic, the server retrieves test traffic relevant to the firewall rule as part of a firewall rule validation process. Relevant test traffic can include test traffic associated with the resource, including test traffic associated with the resource over a specified time period. The server then applies the firewall rule to the test traffic and determines an outcome from applying the firewall rule to the test traffic. Based on an input from the domain owner device, the server performs an action on the firewall rule. Performing the action on the firewall rule based on the input from the domain owner can include validating the firewall rule for application to live request traffic, discarding the firewall rule, or modifying the firewall rule.

In conventional security solutions, an intermediate device (e.g., an edge server) intercepts requests from a client device directed to an origin server. A firewall at the edge server can match simple criteria, such as an exact IP address, country of origin, or user agent. However, existing solutions that require a user to generate individual rules for each individual criterion can result in large rules set that can slow down computing time and utilize significant resources to process traffic. In addition, conventional security solutions test rules using live traffic, which increases the time required to process traffic. Testing on live traffic can also result in malicious or otherwise unwanted traffic reaching the origin server rather than being blocked.

Embodiments of the invention provide many technical advantages, in addition to addressing the deficiencies of previous solutions. For example, the ability to generate firewall rules that matches more than just a single request property and that can partially match request properties by recognizing a string or a pattern provides greater flexibility in firewall rule generation. Using fewer firewall rules that can combine multiple request properties also conserves both computing time and resources that would otherwise be expended to check a greater number of single request property rules. Further, by applying data at rest (e.g., test traffic, historical data requests, etc.), embodiments of the invention provide for testing the effectiveness of a firewall rule prior to validating the firewall rule and exposing it to live traffic. Testing firewall rules against the type of network traffic the resource reasonably expects to receive allows for improved protection and minimizes false positives.

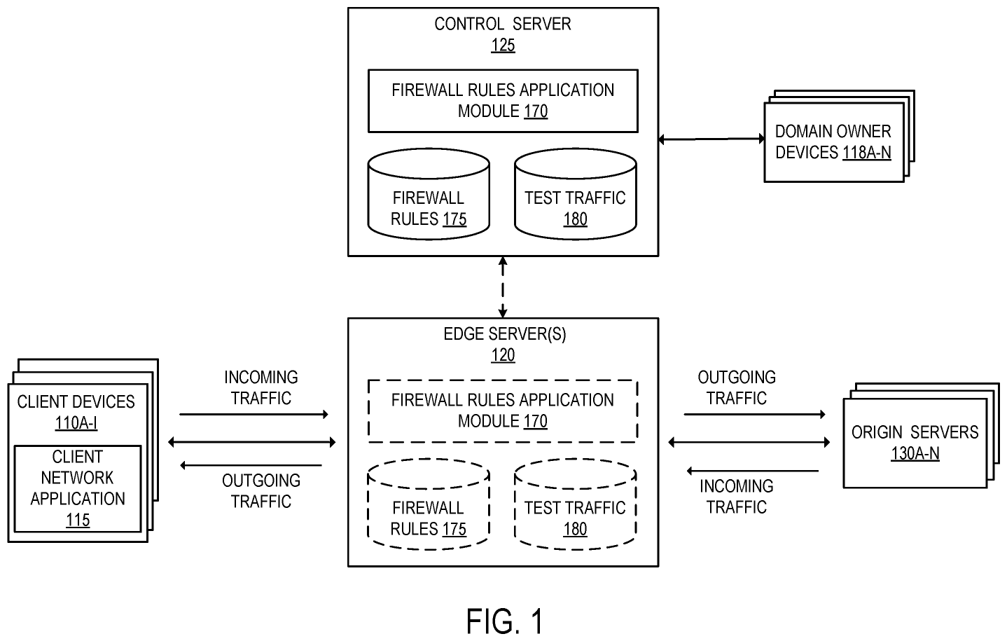

FIG. 1 illustrates an exemplary network architecture that use embodiments described herein. The service illustrated in FIG. 1 includes edge server(s) 120 that are situated between client computing devices 110A-I and origin server(s) 130A-N. In one embodiment, edge server(s) 120 is configured to receive requests to access and/or modify resources hosted by origin servers 130A-N, retrieve and/or analyze properties of the request, and perform actions on the requests prior to sending the request to origin servers 130A-N. For example, web traffic (e.g., HTTP requests/responses, HTTPS requests/responses, SPDY requests/responses, HTTP/2 requests, responses, etc.) for domains handled by origin servers 130A-N may be received and processed at edge server(s) 120. In one embodiment, domain owners are customers of the cloud-based edge service and certain network traffic for their websites are received and processed at edge server(s) 120.

Client devices 110A-I are computing devices (e.g., laptops, workstations, smartphones, palm tops, mobile phones, tablets, gaming systems, set top boxes, wearable devices, electronic devices, etc.) that are capable of transmitting and/or receiving network traffic. In one embodiment, each of client devices 110A-I executes client network application 115 that is capable of transmitting and/or receiving network traffic. For example, client network application 115 may be a web browser or other application that can access network resources (e.g., web pages, images, word processing documents, PDF files, movie files, music files, or other computer files).

Domain owner devices 118A-N are computing devices (e.g., laptops, workstations, smartphones, palm tops, mobile phones, tablets, gaming systems, set top boxes, wearable devices, electronic devices, etc.) that are capable of interfacing with control server 125.

Origin servers 130A-N are computing devices that may serve and/or generate network resources (e.g., web pages, images, word processing documents, PDF files movie files, music files, or other computer files). Origin server 130A-N may also be another edge server to the server that serves and/or generates network resources. Although not illustrated in FIG. 1, it should be understood that the network resources of origin servers 130A-N may be stored separately from the device that responds to the requests. Some of origin servers 130A-N may handle multiple domains that resolve to edge server(s) 120. For example, a single origin server (e.g., origin server 130A) may handle multiple domains owned by the same domain owner or different domain owners through use of virtual hosting. In one embodiment, the virtual hosting is name-based virtual hosting where multiple websites (domains), which may or may not be owned or operated by the same domain owner, are hosted on the same IP address.

The service may also include control server 125, which may be owned or operated by the service. In one embodiment, control server 125 provides a set of tools and interfaces for customers (e.g., domain owners) to configure settings of the service. In some embodiments, control server 125 provides an interface (e.g., a GUI) to domain owners via domain owner devices 118A-N to allow domain owners to configure and modify customizable and/or default firewall rules. In one embodiment, control server 125 further provides the GUI to allow the domain owners to preview the results of applying firewall rules to historical request data. In some embodiments, control server 125 may receive a command from edge server(s) 120 to perform the application of firewall rules to requests described herein. For example, control server 125 may receive a command from a domain owner of a website (e.g., resource) handled by an origin server (e.g., origin server 130A) to apply a set of firewall rules to requests directed to particular resources (or types of resources) associated with the domain owner.

In one embodiment, control server 125, or optionally edge server(s) 120, includes firewall rules application module 170, firewall rules storage 175 and test traffic storage 180. Firewall rules application module 170 is configured to access firewall rules stored in firewall rules storage 175 and apply test traffic from test traffic storage 180 to the accessed firewall rules. In some embodiments, firewall rules application module 170 tests firewall rules by applying data at rest (e.g., the historical request data) and comparing the outcome with expected results. For example, firewall rules application module 170 validates a firewall rule when the filter of the firewall rule matches at least a threshold amount of test traffic applied to the firewall rule. In some embodiment, where the service cannot validate a firewall rule (e.g., the filter of the firewall rule does not match at least the threshold amount of test traffic), the firewall rule can be flagged or otherwise be modified to include an indication that the firewall rule is invalid. In some embodiments, after validating a firewall rule, the service applies the validated firewall rule to subsequent requests received by edge server(s) 120 from client devices (e.g., client devices 110A-I) or client network applications (e.g., client network application 115) operating on client devices.

Firewall rules application module 170 is further configured to analyze traffic intercepted by edge server(s) 120 by applying validated firewall rules and perform actions in response to determining that the traffic matches a filter in one or more firewall rules and perform a corresponding action.

In one embodiment, firewalls rules storage 175 stores default firewall rules and user-generated firewall rules. In some embodiments, firewall rules 175 can include profiles or data structures, where the profiles or data structures store information indicating which firewall rules are associated with an origin server or a resource. In one embodiment, each of origin servers 130A-N, or a subset of origin servers 130A-N, is associated with a profile, where each profile includes an indication of the firewall rules applied to traffic directed to the corresponding origin server. For example, when traffic is directed to a resource hosted by origin server 130A, firewall rules application module 170 identifies (e.g., by accessing a profile associated with origin server 130A) the firewall rules (e.g., in firewall rules 175) associated with origin server 130A.

In one embodiment, test traffic storage 180 stores data at rest. The data at rest can include historical request data from previously analyzed requests processed from edge server(s) 120 or from another edge server other than edge server(s) 120. The data at rest can also include test traffic generated for testing purposes. The test traffic can be tied to information indicating the success rate of prior filtering processes on the test traffic (e.g., whether prior filtering processes successfully or unsuccessfully filtered the test traffic). In one embodiment, firewall rules application module 170 compares the results from applying new or modified firewall rules to the test traffic with the historical results of previous filtering processes.

### I. Firewall Rules

In one embodiment, firewall rules are configurable rules that include a filter for comparison to traffic (e.g., HTTP requests) received at an edge server, e.g., edge server(s) 120, and an action to perform in response to detecting traffic matching a filter. In one embodiment, a firewall rule is composed of a plurality of elements. For example, a firewall rule can include a filter, an action, a priority, a description, an identifier, and a reference value. Some firewall rules can include all or a subset of the above-identified elements. For example, a basic firewall rule can include just a filter and a corresponding action. Firewall rules can be selected from a set of preexisting firewall rules, generated based on templates, and/or user-generated. For example, the preexisting firewall rules can include a default or recommended set of firewall rules.

The filter element contains an expression (e.g., a character string) that firewall rules application module 170 applies to traffic that passes through edge server(s) 120. In one embodiment, the application of a filter to traffic by firewall rules application module 170 will return either true or false, where firewall rules application module 170 flags traffic that matches at least one filter as true and traffic that does not match any filters as false. An example filter expression is:
(http.request.uri.path˜“\hat{ }.*wp-login.php$”
or http.request.uri.path˜“\hat{ }.*xmlrpc.php$”)
and ip.src ne 192.0.2.1
   The above filter expression captures two paths that may be subject to brute force password attacks, and then excludes traffic having a source IP address of 192.0.2.1.

Another example filter expression is:
http.host eq “www.example.com” and ip.src eq 192.0.2.1/24

The above filter expression captures traffic directed to resource “www.example.com” having a source IP address of 192.0.2.1.

In one embodiment, the filter expression can be created using the following fields. Other embodiments include different, fewer, or additional fields.

| | Field | | |
|---|---|---|---|
| Field Name | Type | Example Value | Notes |
| http.cookie | String | session=8521F670545D786 | Whole cookie as a string |
| | | 5F79C3D7BEDC29CCE; | |
| | | background=light | |
| http.host | String | www.example.org | The host name used in the |
| | | | full request URI |
| http.referer | String | | The HTTP referrer header |
| http.request.full_uri | String | https://www.example.org/ | The full URI as received |
| | | articles/index?section=539061 | by the web server (does |
| | | &expand=comments | not include #fragment |
| | | | which is not sent to web |
| | | | servers) |
| http.request.method | String | GET | The HTTP method, upper |
| | | | cased |
| http.request.uri | String | /articles/index?section=539 | The absolute URI of the |
| | | 061&expand=comments | request |
| http.request.uri.path | String | /articles/index | The path of the request |
| http.request.uri.query | String | section=539061&expand= | The whole query string, |
| | | comments | minus the delimit prefix |
| | | | ‘?’ |
| http.user_agent | String | Mozilla/5.0 (X11; Linux | The whole HTTP user |
| | | x86_64) | agent |
| | | AppleWebKit/537.36 | |
| | | (KHTML, like Gecko) | |
| | | Chrome/65.0.3325.181 | |
| | | Safari/537.36 | |
| http.x_forwarded_for | String | | The whole X-Forwarded- |
| | | | For HTTP header |
| ip.src | IP | 192.0.2.1 | The TCP IP address for |
| | Address | | the client, which may be |
| | | | adjusted to reflect the real |
| | | | client IP of the original |
| | | | client as applicable (e.g., |
| | | | using HTTP headers like |
| | | | X-Forwarded-For or X- |
| | | | Real-IP) |
| ip.geoip.asnum | Number | 15133 | The autonomous system |
| | | | (AS) number |
| ip.geoip.country | String | GB | The two-letter country |
| | | | code |
| ssl | Boolean | true | Whether the HTTP |
| | | | connection to the client is |
| | | | encrypted |
| tcp.port | Number | 443 | The TCP port the client |
| | | | connected to when making |
| | | | the request |

In one embodiment, the filter expression can be created using the following additional example fields:

| | Field | Valid | Example | |
|---|---|---|---|---|
| Field Name | Type | Values | Value | Description |
| threat_score | Number | 0-100 | 57 | The value is a risk score. In one |
| | | | | embodiment, 0 indicates low risk, |
| | | | | values above 10 represent spammers or |
| | | | | bots, and values above 40 indicates bad |
| | | | | actors on the internet. One example |
| | | | | rule can challenge requestors with a |
| | | | | risk score above 10, and to block |
| | | | | requestors with a risk score above 50. |
| client_trust_score | Number | 0-100 | 90 | The value is a client trust score. In one |
| | | | | embodiment, 0 indicates low trust of a |
| | | | | client and 100 indicates full trust of the |
| | | | | client. The trust score is derived from |
| | | | | the client and indicates whether the |
| | | | | client presents itself truthfully. In one |
| | | | | embodiment, if a browser user agent is |
| | | | | changed the trust score goes down; if |
| | | | | the TLS behavior does not match |
| | | | | expected behavior, the score goes |
| | | | | down; and if all signals correlate with |
| | | | | knowledge of a client the score goes |
| | | | | up. |

The following example operators can be used in generating filter expressions:

| English | C-like | Description |
|---|---|---|
| eq | == | Equal. |
| ne | != | Not equal. |
| gt | > | Greater than. |
| lt | < | Less than. |
| ge | >= | Greater than or equal to. |
| le | <= | Less than or equal to. |
| contains | | Exactly contains. |
| matches | ~ | Re2 inspired regular expression. |
| in | | Is the value in a set of values |
| bitwise_and | & | Compare bit field value |

The following table indicates example field types that support the above-noted operators, and provides exemplary filter expressions:

| English | String | IP Address | Number | Boolean |
|---|---|---|---|---|
| eq | http.request.uri.path | ip.src eq 192.0.2.1 | tcp.port eq | ssl |
| | eq “/articles/2008/” | | 443 | |
| ne | http.request.uri.path | ip.src ne 192.0.2.1 | tcp.port ne | not ssl |
| | ne “/articles/2010/” | | 80 | |
| gt | http.request.uri.path | | tcp.port gt | |
| | gt “/articles/2006/” | | 7999 | |
| lt | http.request.uri.path | | tcp.port lt | |
| | lt “/articles/2009/” | | 8081 | |
| ge | http.request.uri.path | | tcp.port ge | |
| | ge “/articles/2007/” | | 8000 | |
| le | http.request.uri.path | | tcp.port le | |
| | le “/articles/2008/” | | 8080 | |
| contains | http.request.uri.path | | | |
| | contains “/articles/” | | | |
| matches | http.request.uri.path | | | |
| | ~ “\hat{ }/articles/200[7- | | | |
| | 8]/$” | | | |
| in | http.request.method | ip.src in {192.0.2.1 192.0.2.2} | tcp.port in | |
| | in {“HEAD” “GET”} | ip.src in {192.0.2.1 . . . 192.0.2.5} | { 80 443 } | |
| | | | tcp.port in | |
| | | | {80 443 | |
| | | | 8000 . . . 8080} | |
| bitwise_and | | | tcp.port & | |
| | | | 0x50 | |

More complex filter expressions can be created by combining filter expressions using the additional operators as shown below.

| English | C-like | Description | Example | Precedence |
|---|---|---|---|---|
| not | ! | Logical NOT | not (http.host eq “www.example.com” and | 1 |
| | | | ip.src eq 192.0.2.1/24) | |
| and | && | Logical AND | http.host eq “www.example.com” and | 2 |
| | | | ip.src eq 192.0.2.1/24 | |
| xor | \hat{ }\hat{ } | Logical XOR | http.host eq “www.example.com” xor | 3 |
| | | | ip.src eq 192.0.2.1/24 | |
| or | ∥ | Logical OR | http.host eq “www.example.com” or ip.src | 4 |
| | | | eq 192.0.2.1/24 | |

The action element indicates an action to perform on traffic that matches the filter. Actions can include logging the firewall event performing no further action on the traffic; allowing the traffic and performing no further processing within the firewall rules (e.g., bypass all other firewall rules); presenting a challenge (e.g., a CAPTCHA) and allowing the traffic to proceed upon a client satisfying the challenge; issuing a JavaScript challenge (“js_challenge”) to prevent trivial bots without requiring the client to complete a CAPTCHA and allowing the traffic to proceed upon passing the challenge; and blocking the traffic.

The priority element allows for customizable prioritization of firewall rules, indicating to firewall rules application module 170 to apply the firewall rules in a particular order. In one embodiment, the highest priority is “1” and the lowest priority is “2147483647,” and omission of a value for the property element is equivalent to assigning the lowest priority value. In one embodiment, where multiple firewall rules are assigned the same priority, the firewall rules are ordered by their actions in the following order of precedence: log, allow, challenge, js_challenge, and block. For example, given two firewall rules assigned the same priority (or assigned no priority): “allow requests from IP range X” and “block requests using user agent Y,” if both firewall rules are triggered, “allow request from IP range X” would apply as “allow” has higher precedence than “block.”

The description element includes a text description summarizing the corresponding firewall rule. In one embodiment, the description element is empty by default.

The identifier element is a value assigned by firewall rules application module 170 to the firewall rule. In one embodiment, the identifier element value is a read-only 32-character UUIDv4 identifier. The reference value element includes a unique reference associated with the firewall rule usable to identify or access a filter rule. In contrast to the identifier elements assigned by firewall rules application module 170, the reference element can be user-defined.

### II. Testing Firewall Rules Using Test Traffic

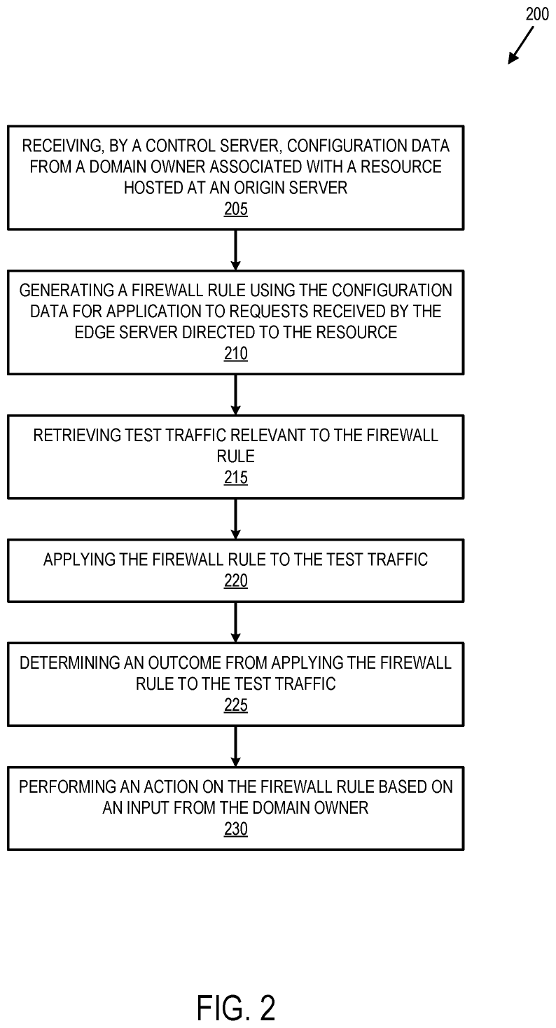

FIG. 2 is a flow diagram 200 that illustrates exemplary operations for generating firewall rules and testing the firewall rules using test traffic according to an embodiment. The operations of FIG. 2 will be described with reference to the exemplary embodiment of FIG. 1. However, it should be understood that the operations of FIG. 2 can be performed by embodiments of the invention other than those discussed with reference to FIG. 1, and the embodiments discussed with reference to FIG. 1 can perform operations different than those discussed with reference to FIG. 2. The operations of FIG. 2 are described as being performed by control server 125. In some embodiment, the operations are performed by firewall rules application module 170 operating on control server 125.

In operation 205, a control server (e.g., control server 125) receives configuration data from a domain owner (e.g., via domain owner devices 118A-N) associated with a resource hosted by an origin server (e.g., origin server 130A). In one embodiment, domain owner devices 118A-N send configuration data to control server 125 via an application programming interface (API) or a graphical user interface (GUI) provided by control server 125. The configuration data can include values for elements of a firewall rule, including a filter, a firewall action, a priority, a description, an identifier, and a reference value. The configuration data can also include user-defined criteria for testing the firewall rule, including a user-defined or specified time period for test traffic to test against the firewall rule.

In one embodiment, the configuration data can include a user selection of a default or recommended configuration containing a set of preestablished firewall rules. The default or recommended configuration can be modified to include additional or fewer firewall rules.

In operation 210, control server 125 generates a firewall rule using the configuration data, the firewall rule for application to requests received by edge server 120 directed to the resource. For example, control server 125 can generate a simple firewall rule containing a filter, a firewall action, and an identifier (e.g., for reference by control server 125). Control server 125 can also generate a more detailed firewall rule containing one or more other firewall rule components, including a priority, a description, and a reference value. In one embodiment, control server 125 stores the firewall rule in a firewall rules storage (e.g., firewall rules storage 175), e.g., by associating the firewall rule with the appropriate resource profile or origin server profile.

In operation 215, control server 125 retrieves test traffic relevant to the firewall rule. In one embodiment, control server 125 identifies test traffic to apply to one or more firewall rules by accessing a test traffic storage (e.g., test traffic storage 180).

In one embodiment, firewall rule application module 170 identifies test traffic associated with a specific domain or a specific resource (e.g., web page). For example, the identified test traffic can be actual historical request data for the specific domain to demonstrate the impact of the firewall rules on expected traffic to the specific domain. In one embodiment, firewall rule application module 170 selects the actual historical request data for the specific domain over a specified time period. For example, the actual historical request data for the last hour, last 24 hours, last week, last month, etc., to determine how the firewall rules would have performed if they had been in effect over the specified time period.

In another embodiment, firewall rule application module 170 identifies default or general test traffic. The default or general test traffic can be associated with a default or recommended firewall rule. In another example, the default or general test traffic can be selected based on similar types of resources to the specific resource (e.g., based on content or having similar amounts of traffic).

In operation 220, control server 125 applies the firewall rule to the test traffic. For example, given a domain owner request to test a firewall rule against the last six hours of historical request data for the specific domain or resource, control server 125 applies the firewall rule to the specified historical request data. In one embodiment, the test traffic is stored in test traffic storage 180 in a data structure that logs some or all of the information regarding each request (i.e., request properties), except for sensitive information (e.g., post data, user credentials, other uploads, etc.). In one embodiment, request properties can include primitive properties, derived values, and computed values. Primitive properties can include properties obtained directly from the traffic, including the path value for “http.request.uri.path.” Derived values can include properties that are the result of transformation, composition or basic operations. For example, a derived value may be generated by making the path “http.request.uri.path” all lowercase and available as a field of another field. Computed values can include properties that are the result of lookup, computation, or intelligence. An example of a computed value is a threat score (e.g., threat score) calculated dynamically by a machine learning process that is inspecting the primitive properties and derived fields.

In one embodiment, when applying the firewall rule to the test traffic, control server 125 (e.g., via firewall rules application module 170) generates a query to the data structure. For example, control server 125 parses the filter expression of the firewall rule and generates a graphQL query to apply to the data structure.

In operation 225, control server 125 determines an outcome from applying the firewall rule to the test traffic. In one embodiment, the outcome from applying the firewall rule to the test traffic is an indication of an amount of test traffic, and the specific test traffic, that matched the firewall rule. For example, given a firewall rule to block all traffic for an IP address in the range 192.0.2.0/24, control server 125 generates a query to the data structure storing the historical request data to determine the number of historical requests received from that IP address range. The results of the query can also indicate the number of requests that did not match the firewall rule, and thus would have been allowed.

In one embodiment, control server 125 displays the outcome of the test of the firewall rule. In one embodiment, control server 125 displays a graphical representation (e.g., via a GUI) indicating the effect of the firewall rule. For example, the graphical representation can display an indication of the total amount of traffic tested and the total amount of affected traffic (e.g., traffic that matched, was blocked, or was allowed, by the firewall rule).

In operation 230, control server 125 performs an action on the firewall rule based on an input from the domain owner received from domain owner device 118A. In one embodiment, control server 125 receives the input in response to a prompt based on the determined outcome from applying the firewall rule to the test traffic. For example, control server 125 prompts the user as to whether the firewall rule should be validated. If the user validates the firewall rule, control server 125 applies the firewall rule to subsequent traffic received by edge server(s) 120 that is directed to the domain associated with the firewall rule. Otherwise, the firewall rule is discarded or otherwise not applied to future traffic.

### III. Applying Validated Firewall Rules to Live Traffic

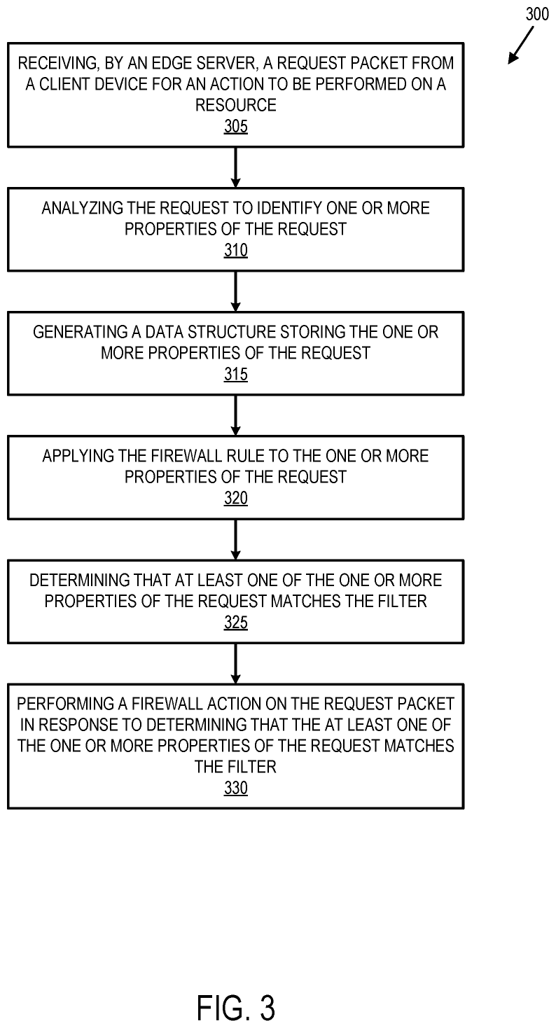

FIG. 3 is a flow diagram 300 that illustrates exemplary operations for applying firewall rules to a request packet according to an embodiment. The operations of FIG. 3 will be described with reference to the exemplary embodiment of FIG. 1. However, it should be understood that the operations of FIG. 3 can be performed by embodiments of the invention other than those discussed with reference to FIG. 1, and the embodiments discussed with reference to FIG. 1 can perform operations different than those discussed with reference to FIG. 3. The operations of FIG. 3 are described as being performed by one or more edge servers (e.g., edge server(s) 120). In some embodiment, the operations are performed by firewall rules application module 170 operating on edge server(s) 120.

In operation 305, the edge server (e.g., edge server 120) receives a request packet from a client device (e.g., client device 110A) for an action to be performed on a resource. For example, edge server 120 receives an HTTP “GET” request to access a resource hosted by an origin server (e.g., origin server 130A). In one embodiment, the requested resource is an HTML page located at, e.g., www.example.com. The request packet may include a request for an action to be performed on the resource. In one embodiment, edge server 120 receives the request packet because of a DNS for the hostname resolving to an IP address assigned to edge server 120 instead of resolving to an IP address of the origin server hosting the resource.

In operation 310, edge server 120 analyzes the request to identify one or more properties of the request. In one embodiment, request properties can include primitive properties, derived values, and computed values. Primitive properties can include properties obtained directly from the traffic, including the path value for “http.request.uri.path.” Derived values can include properties that are the result of transformation, composition or basic operations. For example, a derived value may be generated by making the path “http.request.uri.path” all lowercase and available as a field of another field. Computed values can include properties that are the result of lookup, computation, or intelligence. An example of a computed value is a threat score (e.g., threat score) calculated dynamically by a machine learning process that is inspecting the primitive properties and derived fields. In one embodiment, the request properties can include a date and time that edge server 120 received the request.

In operation 315, edge server 120 generates a data structure storing the one or more properties of the request. In one embodiment, edge server 120 generates a table, or a comparable data structure, of request properties that will be matched against the filters of the firewall rule being tested. In one embodiment, edge server 120 sends the data structure of request properties to control server 125 (e.g., for use as historical request data for future testing of firewall rules). In one embodiment, control server 125 stores the request properties for a request for a specific amount of time (e.g., one week, one month, etc.). In one embodiment, the table or data structure persists until edge server 120 makes a determination as to an action to perform on the request packet. In one embodiment, edge server 120 does not store sensitive information, including POST data and user credentials (e.g., user name, password, etc.).

In operation 320, edge server 120 applies the firewall rule to the one or more properties of the request. In one embodiment, edge server 120 retrieves the relevant firewall rules from control server 125. For example, edge server 120 retrieves all firewall rules associated with the domain of the request. Each firewall rule includes at least a filter that contains an expression, as described previously. In one embodiment, edge server 120 applies the filter expression to the one or more properties of the request to identify any properties of the request that match. For example, edge server 120 can match various properties of the request to a filter expression, including the source IP address, the source country, the user agent, etc.

Where one or more of the firewall rules have been assigned priority values, edge server 120 applies the firewall rules starting from the firewall rule with the lowest priority number value (e.g., equivalent to being the highest priority firewall rule) to the highest priority number value, with firewall rules without priority values applied last.

In operation 325, edge server 120 determines that at least one of the one or more properties of the request matches the filter.

In operation 330, edge server 120 performs a firewall action on the request packet in response to determining that the at least one of the one or more properties of the request matches the filter. In one embodiment, the firewall actions can include logging the firewall event and performing no further action on the traffic, allowing the traffic and performing no further processing within the firewall rules (e.g., bypass all other firewall rules), presenting a challenge (e.g., a CAPTCHA) and allowing the traffic to proceed upon a received challenge response satisfying the challenge, issuing a JavaScript challenge (“js_challenge”) to prevent trivial bots without requiring the client to complete a CAPTCHA and allowing the traffic to proceed upon passing the challenge, and blocking the traffic.

In an alternative embodiment, where edge server 120 sends the data structure of request properties to control server 125, control server 125 performs the steps in operations 320 and 325. In such embodiments, control server 125 sends the outcome of the application of the firewall rules to the request properties to edge server 120 to perform the firewall action (as described in operation 330).

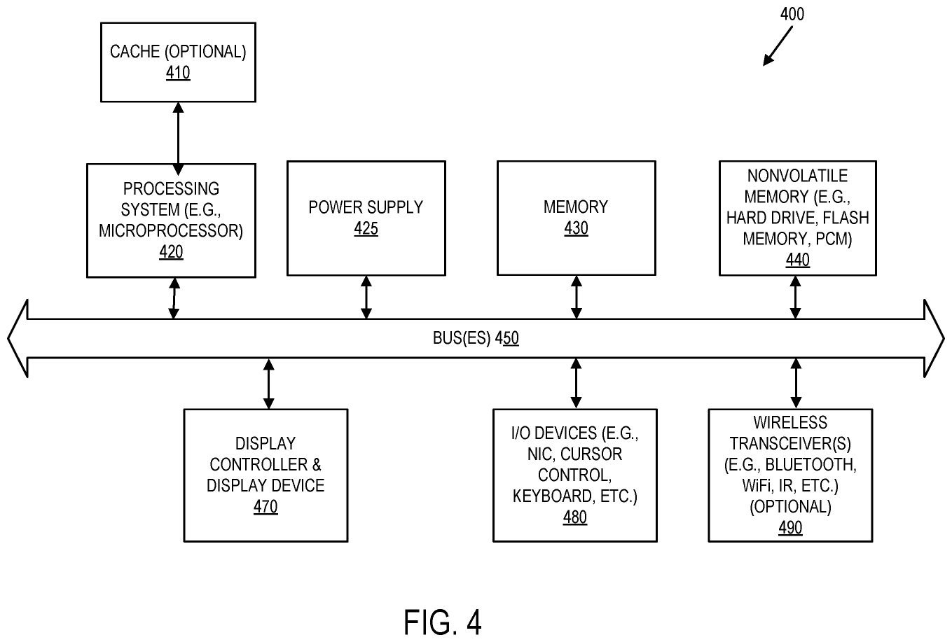

FIG. 4 is a block diagram illustrating a data processing system that can be used in an embodiment. As illustrated in FIG. 4, the computer system 400, which is a form of a data processing system, includes the bus(es) 450 which is coupled with the processing system 420, power supply 425, memory 430, and the nonvolatile memory 440 (e.g., a hard drive, flash memory, Phase-Change Memory (PCM), etc.). The bus(es) 450 may be connected to each other through various bridges, controllers, and/or adapters as is well known in the art. The processing system 420 may retrieve instruction(s) from the memory 430 and/or the nonvolatile memory 440 and execute the instructions to perform operations described herein. The bus 450 interconnects the above components together and interconnects those components to the display controller & display device 470, Input/Output devices 480 (e.g., NIC (Network Interface Card), a cursor control (e.g., mouse, touchscreen, touchpad, etc.), a keyboard, etc.), and the optional wireless transceiver(s) 490 (e.g., Bluetooth, Wi-Fi, Infrared, etc.). In one embodiment, the computer system 400 includes a cache 410. In one embodiment, the client devices, the edge server(s), the control server, and the origin servers described herein may take the form of the computer system 400.

The techniques shown in the figures can be implemented using code and data stored and executed on one or more computing devices (e.g., client devices, servers, etc.). Such computing devices store and communicate (internally and/or with other computing devices over a network) code and data using machine-readable media, such as machine-readable storage media (e.g., magnetic disks; optical disks; random access memory; read only memory; flash memory devices; phase-change memory) and machine-readable communication media (e.g., electrical, optical, acoustical or other form of propagated signals—such as carrier waves, infrared signals, digital signals, etc.). In addition, such computing devices typically include a set of one or more processors coupled to one or more other components, such as one or more storage devices, user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given computing device typically stores code and/or data for execution on the set of one or more processors of that computing device. Of course, one or more parts of an embodiment of the invention may be implemented using different combinations of software, firmware, and/or hardware.

In the preceding description, numerous specific details are set forth. However, it is understood that embodiments of the invention may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the preceding description and the claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method, comprising:
receiving, by a control server, configuration data from a domain owner device associated with a domain owner of a resource hosted by an origin server;
generating a firewall rule using the configuration data, the firewall rule for application to requests received by an edge server directed to the resource;
retrieving test traffic relevant to the firewall rule;
applying the firewall rule to the test traffic;
determining an outcome from applying the firewall rule to the test traffic; and
performing an action on the firewall rule based on an input from the domain owner device.

2. The method of claim 1, wherein retrieving the test traffic relevant to the firewall rule includes:
identifying the test traffic associated with the resource; and
filtering the test traffic associated with the resource based on a specified time period.

3. The method of claim 2, wherein the test traffic is from previously analyzed requests directed to the resource processed by edge server over the specified time period.

4. The method of claim 1, wherein performing the action on the firewall rule based on the input from the domain owner includes:
validating the firewall rule for application to live request traffic.

5. The method of claim 4, wherein the method further comprises:
receiving, by the edge server, a request packet from a client device including a request for an action to be performed on the resource;
analyzing the request to identify one or more properties of the request;
generating a data structure storing the one or more properties of the request;
applying the firewall rule to the one or more properties of the request, the firewall rule including a filter and a firewall action;
determining that at least one of the one or more properties of the request matches the filter; and
performing the firewall action on the request packet in response to determining that the at least one of the one or more properties of the request matches the filter.

6. The method of claim 5, wherein performing the firewall action on the request packet includes:
logging the determination that the at least one of the one or more properties of the request matches the filter.

7. The method of claim 5, wherein performing the firewall action on the request packet includes:
presenting a challenge to the client device;
validating a challenge response to the challenge received from the client device; and
sending the request packet to the origin server hosting the resource in response to validating the challenge response to the challenge.

8. A non-transitory machine-readable storage medium that provides instructions that, when executed by a processor, cause said processor to perform operations comprising:
receiving, by a control server, configuration data from a domain owner device associated with a domain owner of a resource hosted by an origin server;
generating a firewall rule using the configuration data, the firewall rule for application to requests received by an edge server directed to the resource;
retrieving test traffic relevant to the firewall rule;
applying the firewall rule to the test traffic;
determining an outcome from applying the firewall rule to the test traffic; and
performing an action on the firewall rule based on an input from the domain owner device.

9. The non-transitory machine-readable storage medium of claim 8, wherein retrieving the test traffic relevant to the firewall rule includes:
identifying the test traffic associated with the resource; and
filtering the test traffic associated with the resource based on a specified time period.

10. The non-transitory machine-readable storage medium of claim 9, wherein the test traffic is from previously analyzed requests directed to the resource processed by edge server over the specified time period.

11. The non-transitory machine-readable storage medium of claim 8, wherein performing the action on the firewall rule based on the input from the domain owner includes:
validating the firewall rule for application to live request traffic.

12. The non-transitory machine-readable storage medium of claim 11, wherein the instructions further causes said processor to perform operations comprising:
receiving, by the edge server, a request packet from a client device including a request for an action to be performed on the resource;
analyzing the request to identify one or more properties of the request;
generating a data structure storing the one or more properties of the request;
applying the firewall rule to the one or more properties of the request, the firewall rule including a filter and a firewall action;
determining that at least one of the one or more properties of the request matches the filter; and
performing the firewall action on the request packet in response to determining that the at least one of the one or more properties of the request matches the filter.

13. The non-transitory machine-readable storage medium of claim 12, wherein performing the firewall action on the request packet includes:
logging the determination that the at least one of the one or more properties of the request matches the filter.

14. The non-transitory machine-readable storage medium of claim 12, wherein performing the firewall action on the request packet includes:
presenting a challenge to the client device;
validating a challenge response to the challenge received from the client device; and
sending the request packet to the origin server hosting the resource in response to validating the challenge response to the challenge.

15. An apparatus, comprising:
a processor;
a non-transitory machine-readable storage medium coupled with the processor that stores instructions that, when executed by the processor, cause said processor to perform the following:
receive, by a control server, configuration data from a domain owner device associated with a domain owner of a resource hosted by an origin server;
generate a firewall rule using the configuration data, the firewall rule for application to requests received by an edge server directed to the resource;
retrieve test traffic relevant to the firewall rule;
apply the firewall rule to the test traffic;
determine an outcome from applying the firewall rule to the test traffic; and
perform an action on the firewall rule based on an input from the domain owner device.

16. The apparatus of claim 15, wherein retrieving the test traffic relevant to the firewall rule includes:
identifying the test traffic associated with the resource; and
filtering the test traffic associated with the resource based on a specified time period.

17. The apparatus of claim 16, wherein the test traffic is from previously analyzed requests directed to the resource processed by edge server over the specified time period.

18. The apparatus of claim 15, wherein performing the action on the firewall rule based on the input from the domain owner includes:
validating the firewall rule for application to live request traffic.

19. The apparatus of claim 18, wherein the instructions further cause said processor to perform the following:
receive, by the edge server, a request packet from a client device including a request for an action to be performed on the resource;
analyze the request to identify one or more properties of the request;
generate a data structure storing the one or more properties of the request;
apply the firewall rule to the one or more properties of the request, the firewall rule including a filter and a firewall action;
determine that at least one of the one or more properties of the request matches the filter; and
perform the firewall action on the request packet in response to determining that the at least one of the one or more properties of the request matches the filter.

20. The apparatus of claim 19, wherein performing the firewall action on the request packet includes:
logging the determination that the at least one of the one or more properties of the request matches the filter.

21. The apparatus of claim 19, wherein performing the firewall action on the request packet includes:
presenting a challenge to the client device;
validating a challenge response to the challenge received from the client device; and
sending the request packet to the origin server hosting the resource in response to validating the challenge response to the challenge.
